(19) United States
(12) Patent Application Publication
(10) Pub. No.: US 2021/0370776 A1
(43) Pub. Date: Dec. 2, 2021

(54) ROAD PAVER WITH OPERATING UNIT

(71) Applicant: JOSEPH VOEGELE AG, Ludwigshafen/Rhein (DE)

(72) Inventors: Martin BUSCHMANN, Neustadt (DE); Tom GLOECKNER, Bockenheim (DE); Ralf WEISER, Ladenburg (DE); Bastian FLEISCHER, Waghaeusel (DE); Maximilian THEOBALD, Ludwigshafen (DE)

(73) Assignee: JOSEPH VOEGELE AG, Ludwigshafen/Rhein (DE)

(21) Appl. No.: 17/331,528

(22) Filed: May 26, 2021

(30) Foreign Application Priority Data
May 29, 2020 (EP) 20177342.1

(51) Int. Cl. B60K 35/00; E01C 19/48

(52) U.S. Cl. CPC B60K 35/00; E01C 19/48; E01C 2301/30; B60K 2370/33; B60K 2370/152; B60K 2370/167; B60Y 2200/414

(57) ABSTRACT

A road paver includes a control system, a main operator control stand, a height-adjustable roof, a main drive, at least one lighting element and a paving screed. The road paver further comprises an operating unit, which is arranged outside the main operator control stand and has a plurality of operating elements, of which an operating element is operable to switch the control system on and/or off, an operating element is operable to lift and/or lower the roof an operating element is operable to start and/or stop the main drive, an operating element is operable to switch on and/or off at least one lighting element, and an operating element is operable to lift and/or lower the paving screed.

### CROSS-REFERENCE TO RELATED APPLICATIONS

This application claims foreign priority benefits under 35 U.S.C. § 119(a)-(d) to European patent application number EP 20177342.1, filed May 29, 2020, which is incorporated by reference in its entirety.

### TECHNICAL FIELD

The present disclosure refers to a road paver for paving a road surface.

### BACKGROUND

Before starting paving operation, a number of preparatory activities must be carried out to make a road paver ready for operation. For example, a lowered roof of a main operator control stand must be moved upwards, the paving screed must be lowered, a main drive must be started and a control system must be set to an operating mode. Complementary activities are carried out accordingly after the end of operation, in particular to protect the road paver from effects of the weather and vandalism, to move it or to load it for transport.

From EP 3 214 223 B1 it is known to set a road paver into a loading state, after operating a single switch of an operating unit arranged on the side of the chassis of the road paver, by automatically starting a process in which a roof is lowered, a paving screed and an auger are lifted, and the paving screed, if formed as an extending screed, is retracted.

### SUMMARY

An object of the present disclosure is to provide a road paver with improved operating capabilities.

The object is solved by a road paver according to the disclosure as well as a method for operating a road paver according to the disclosure.

A road paver according to the disclosure comprises a control system, a main operator control stand, a height-adjustable roof, a main drive, at least one lighting element and a paving screed. Furthermore, the road paver comprises an operating unit, which is arranged outside the main operator control stand and comprises a plurality of operating elements, of which an operating element is operable to switch the control system on and/or off, an operating element is operable to lift and/or lower the roof, an operating element is operable to start and/or stop the main drive, an operating element is operable to switch at least one lighting element on and/or off, and an operating element is operable to lift and/or lower the paving screed.

The operating elements can be configured differently and, depending on their function, for example as a switch, button, control knob, lever, touch-sensitive touchscreen, in the form of an ignition lock that can be operated with an insertable key, or similar. The function, and thus the operation, can be adapted to match the physical design of the respective operating element. One, two or a plurality of operating elements may be provided for the respective functions. For example, the same button can switch on a function of the road paver when pressed for the first time and switch the function off again when pressed again. Likewise, a button can give the opposite control command depending on the current status of the function, i.e., switch on a motor when it is off and vice versa. Likewise, a function of the road paver can be changed depending on a frequency and/or length of operation of an operating element. For example, pressing and holding a button can dim a light so that its brightness increases. On the other hand, if the button is pressed twice in quick succession and held down during the second pressing operation, the brightness is dimmed down. Likewise, separate buttons can be provided for complementary functions or for states of a function, for example a button for lifting the roof and a button for lowering it. A button can also be adapted in such a way that it is possible not only to switch between two discrete states, for example on/off, position up/down, but also to set intermediate states continuously, for example the roof is lowered or lifted continuously or in steps depending on how long the operating element is actuated. Likewise, three or more buttons can also be provided for different states of a function. For example, one button can move the paving screed to an uppermost position, a second button can move the paving screed to a middle position, and a third button can move the paving screed to a lowermost position.

It is expedient that the buttons are adapted in such a way that there are no openings into the interior of the operating unit, but instead, for example, an elastic cover merely transmits the pressure to an electronic component underneath.

With an operating unit according to the disclosure, it is now possible to carry out preparatory or final work on the road paver from outside the main operator control stand, in particular the operating unit is mounted at a position on the road paver which can be reached by an operator standing on the ground. Since all relevant adjustment options can be addressed separately by their own operating elements, the operator can actuate the relevant functions at any given time. This reduces the time required and also increases safety for the persons present.

Switching the control system on and off can have similar functions to switching the ignition on and off in a passenger car. It allows the machine control system to start up even before the operator climbs onto the machine. Thus, functions based on the electrical supply, such as lighting, can be turned on without the need to run a main drive, such as a diesel engine. This main drive can in turn be started and stopped, for example, by pressing a start/stop button. Likewise, the ignition and main drive could be actuated depending on a turn of the key in an ignition lock. Ideally, the ignition lock is equivalent to that of the main operator control stand. The fact that this is now already possible from outside the main operator control stand of the road paver means that the roof can be lifted and lowered using a hydraulic system operated by the main drive, in particular the main hydraulic system. Likewise, the lifting and lowering of the paving screed can now be done from outside the main operator control stand using a hydraulic system powered by the diesel engine. This means that there is no need for an additional electric hydraulic power unit. The functions of the machine are available much sooner, resulting in time savings.

The operator no longer has to climb onto the main operator control stand to operate the functions mentioned, which saves time on the one hand, but also makes work easier and increases safety, as this has so far been very difficult with the paving screed lifted and/or the roof lowered. Before starting work, the paving screed can now be lowered to ground level, making it much easier to climb onto the machine. After work is completed, the paving screed can be lifted, making it more difficult to climb on and thus also making vandalism more difficult.

In addition, the full working lights can be switched on as soon as the motor is running. On the one hand, this means that necessary setting-up work can be started directly at night, and on the other hand, this leads to increased safety in the entire area around the road paver.

The operating unit may be detachably arranged on the road paver. The operating unit can be screwed to the road paver, snapped into place, plugged in, or fixed to the road paver by means of a magnet or the like. In this way, the operating unit can be removed from the road paver at the end of operation and stored safely elsewhere so that no unauthorized operation is possible. This also eliminates the need for a key or similar identification system, which may otherwise be provided. In addition, for example, the operating unit may normally be located on the paving screed, but may be relocated to a support on the rear wall of the road paver when the paving screed is removed from the road paver.

In an advantageous variant, the operating unit is connected to the control system by means of a cable, in particular by means of a detachable plug connection. The data for controlling the functions of the operating unit can be transmitted via a cable connection. In addition, a power supply can be provided via the cable connection, which is necessary for operating the operating unit, whereby the operating unit can also have power store units, in particular rechargeable batteries, which can be charged via the cable connection.

The operating unit is expediently connected to the control system by means of a radio connection. In this way, the operating unit can also be used when it is removed from the road paver. This allows an operator to operate the functions at a distance from the road paver and thus with an improved overview. If the operating unit is attached to the road paver, data can also be exchanged via a radio connection or a cable connection. To eliminate the need for cable connections in general, charging of current or voltage storage units can also take place inductively in the operating unit. This completely eliminates the need for plug-in connections that can be impaired by weather conditions.

The operating unit may be arranged on the paving screed. In this case, the operating unit can be positioned on existing components of the paving screed so that it is easily accessible. In particular, when loading the road paver onto a low-loader, only the area behind the paving screed is accessible, so that mounting on the side of the paver chassis would be disadvantageous.

In another advantageous variant, the operating unit is arranged on a paving screed climb. The paving screed climb is the access to the main operator control stand, which usually leads over the paving screed at the rear of the road paver and is characterized, for example, by planar treads and a handrail or railing. Here, the operating unit is easily accessible to the driver, especially if the operating unit is located at the lower section on the paving screed. Since the driver climbs up to the main operator control stand anyway afterwards, there are no paths around the road paver, in contrast to a lateral arrangement of the operating unit on the road paver. This results in further time savings.

In one variant, the road paver has a lockable cover which prevents access to the operating unit when locked. This can be a hinged flap, for example, which can be opened and closed. In this way, the operating unit is protected from dirt and the effects of the weather. The cover can comprise a locking mechanism which allows locking and unlocking, for example by means of a suitable key. For this purpose, the operating unit can be arranged in a recess which is locked by the cover in the manner of a box. The cover is made of stable sheet metal. The cover can be arranged on the paving screed so that the operating unit is easily accessible for use at the corresponding position and only the cover has to be opened for this purpose. Likewise, the cover can also be arranged, for example, at a position on the chassis of the road paver, where the operating unit is merely moved for storage when not needed, for example, at the end of work.

In a further practical variant, the operating unit has one or a plurality of display elements, each of which displays information about one of the components that can be adjusted by means of the operating elements. For example, light spots in the colors red, green, yellow can be provided to indicate an operating status of the main drive or the control system, or a locking status of the paving screed or the roof. Likewise, numbers or a writing can also be displayed on one or a plurality of suitable displays. This provides the operator with information on the status of the respective functional element and the settings that can be made.

At least one lighting element may be configured to go out after a predetermined period of time has elapsed following operation of the operating element to switch at least one lighting element on or off. This allows the operator to safely move away from the road paver. Any amount of time may be provided, such as 10, 30, or 60 seconds. The operating element may be configured such that when operated, a lighting element that is already on is turned off after the predetermined time period. Likewise, the lighting element may be initially switched on, only to be switched off again after the predetermined time period. A plurality of lighting elements can also be switched accordingly via the same operating element. In addition, different switching times can be provided depending on an operation of the operating element. For example, pressing the operating element twice in quick succession can trigger a lighting period twice as long as pressing it once. It would also be conceivable to control an illumination intensity, i.e., brightness, as a function of a duration of pressing the operating element, for example. It is also possible to provide for one or a plurality of lighting elements to go out with a time delay when the ignition is switched off, whether at the main operator control stand or the operating unit.

In a further practical variant, a lifting mechanism is provided for lifting and lowering the roof, which comprises an automatically releasable and automatically lockable end position lock. This means that it is no longer necessary to climb onto the main operator control stand in order to manually fix the roof in its end position, for example the lifted operating position, by means of bolts or the like. This makes the work much easier and saves time. Automatic roof locking can be performed in several ways. For example, bolting is possible with the aid of an additional actuator, such as a hydraulic cylinder or electric servomotor. Force-locking is also possible with the aid of an appropriate clamping element. It is also conceivable to hermetically seal off the chambers of the roof lifting cylinder with the aid of suitable valves. The latter two solutions offer the additional advantage that the roof can be locked in any position. Appropriate hydraulic cylinders can be used for the variants mentioned.

In another advantageous embodiment, the control system is configured to allow the main drive to be started even before the control system itself is fully placed in an operating mode after power-up. The control system may have a programming such that initially after power-up, for example by turning an ignition key, the control system enters a start mode. This mode can be characterized by the fact that only software parts of small volume are loaded into a working memory or are already present in it, so that relatively quickly, almost without noticeable time delay, their functions are available. In this start mode, the functions for starting the main drive are available, whereby the start can be made, for example, by pressing a start button or by continuing to turn an ignition key. Following the start mode, further software parts can then be reloaded or activated, so that the control system changes over to the operating mode, in which all machine functions are available. Changing to operating mode may also involve the control system querying interfaces to identify which configuration the road paver is set up in, such as which paving screed is installed on the tractor. This allows the control system to be fully started in parallel with climbing onto the machine and preparatory measures for operation, as well as with the main drive already started, which represents a significant time saving.

In a further practical variant, the operating unit has operating elements which are provided for controlling functions of the road paver in the paving mode. In this way, corresponding controls, for example changing the paving screed settings, can also be carried out from the same operating unit. This reduces the amount of cabling and maintenance required.

A method according to the disclosure for operating a road paver comprising a control system, a main operator control stand, a height-adjustable roof, a main drive, at least one lighting element, a paving screed, and an operating unit having a plurality of operating elements, comprises the method steps:
operating an operating element to switch at least one lighting element on and/or off,
operating an operating element to lift and/or lower the roof,
operating an operating element to start and/or stop the main drive,
operating an operating element to lift and/or lower the paving screed, and
operating an operating element to switch the control system on and/or off.

The main drive may be started before the control system is fully placed in an operating mode after power-up. As explained above, the control system can first enter a start mode with limited functionality and thus low computational load for a processor and a working memory, and then load or activate the full operating software to enter an operation mode. In the start mode, it is already possible to start the main drive, which means that secondary systems such as lighting or a hydraulic system can also be available at an early stage as soon as their operation is permitted by the control system, which may also already be the case in the start mode.

### BRIEF DESCRIPTION OF THE DRAWINGS

In the following, embodiments of the disclosure are described in more detail with reference to the Figures.

FIG. 1 shows a perspective view of a road paver;

FIG. 2 shows a schematic representation of an operating unit;

FIG. 3 shows a perspective representation of an operating unit;

FIG. 4 shows a perspective representation of an operating unit arranged on the road paver;

FIG. 5 shows a schematic representation of a lifting mechanism for roof adjustment with hydraulic cylinder with end position lock;

FIG. 6 shows a sectional view of a hydraulic cylinder with end position lock;

FIG. 7 shows a schematic representation of an end position lock by means of an automatically movable bolt; and

FIG. 8 shows a schematic representation of an end position lock using a rotary snap lock.

Corresponding components are marked with the same reference numerals in the Figures.

### DETAILED DESCRIPTION

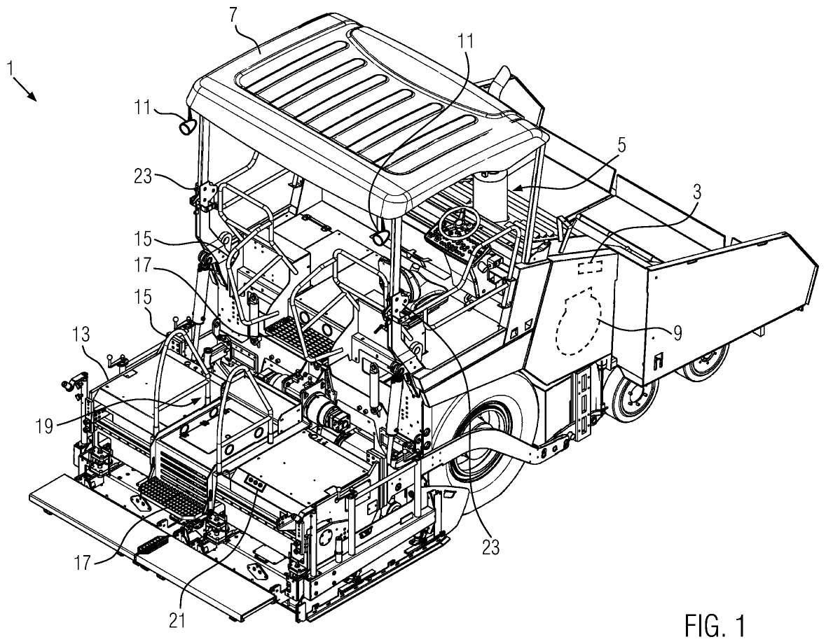

FIG. 1 shows a road paver 1 with a control system 3, a main operator control stand 5, a height-adjustable roof 7, a main drive 9, lighting elements 11 and a paving screed 13. The control system 3 and main drive 9 are shown here as being concealed under a chassis cover. The main drive 9 is typically a diesel engine. The paving screed 13 can have a fixed width or can have extension parts with which the paving screed width can be increased. A paving screed climb 19 is formed to the main operator control stand 5 with railing parts 15 and treads 17. An operating unit 21 is arranged on the paving screed 13 in the direct vicinity of the paving screed climb 19. In the same way, however, the operating unit 21 can also be provided directly on a railing part 15 or at another suitable location. The roof 7 is mounted so that it can be adjusted in height by means of a lifting mechanism 23.

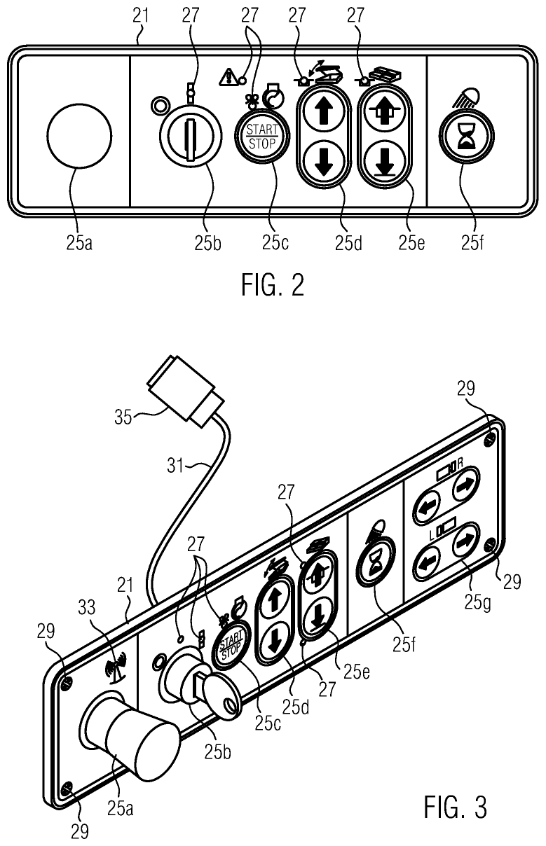

FIG. 2 shows a schematic representation of an operating unit 21 with a plurality of operating elements 25, which in this example are an emergency stop key 25a, an ignition lock 25b to switch on the ignition, a start/stop button 25c for the main drive, in each case an operating element 25d to lift and lower the roof 7, in each case an operating element 25e to lift and lower the paving screed 13, and an operating element 25f for time-delayed switching off of a lighting element 11. Display elements 27 are provided in the form of light spots, for example in the colors red, green or yellow, which indicate a state of ignition, of the main drive 9, of a locking of the roof 7 or of a locking of the paving screed 13.

FIG. 3 shows a perspective view of an operating unit 21 with the operating elements 25a-f and the display elements 27. In addition, operating elements 25g are provided which serve to control functions of the road paver 1 in paving mode, i.e., in particular functions relevant for the paving operation itself. Operating elements 25g for adjusting left and right extension elements of the paving screed 13 are shown here as an example. The operating unit 21 can be detachably attached to the road paver 1, for example by means of a magnet, or it can be permanently installed or be detachable only with tools. In this representation, four screws 29 illustrate a permanently installed variant. In all variants, the operating unit 21 can be connected to the control system 3 of the road paver 1, or to a bus system, by means of a cable connection 31 and/or radio connection 33, which is shown here symbolically, since the necessary antennas and components are usually concealed inside the operating unit 21. A detachable plug connection 35 may be arranged on the cable 31.

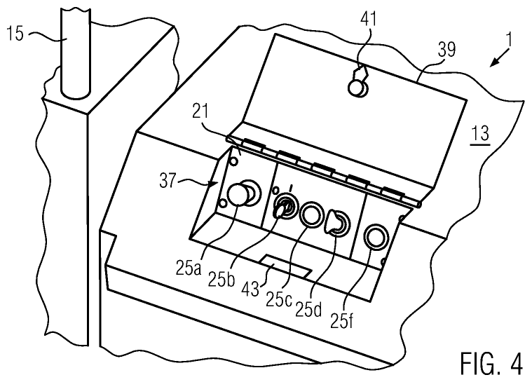

FIG. 4 shows a perspective view of an operating unit 21 arranged on the road paver 1, for example on the paving screed 13 in the position shown in FIG. 1. The operating unit 21 is arranged in a recess 37, which can be closed by a pivotable cover 39. The cover 39 has a locking mechanism 41 in the form of a rotatable latch with which the closed cover 39 can be locked, for example with a key, by the locking mechanism 41 engaging in a recess 43. In this way, unauthorized access to the operating unit is prevented. The arrangement and structure of the operating elements 25 deviates from the representation in FIG. 3. Lifting and lowering of the roof 7 is provided, for example, with a rotary button as operating element 25d.

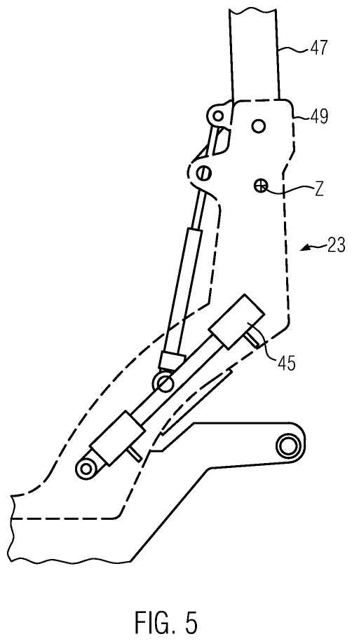

FIG. 5 shows a schematic diagram of a lifting mechanism 23 for roof adjustment with a hydraulic cylinder 45 with a built-in end position lock. The hydraulic cylinder 45 rotates the upper linkage part 47 against the base part 49 about an axis of rotation Z to fold the roof forward and downward. The end position lock in the hydraulic cylinder 45 can be mechanical, as described above, or by means of valve control, for example.

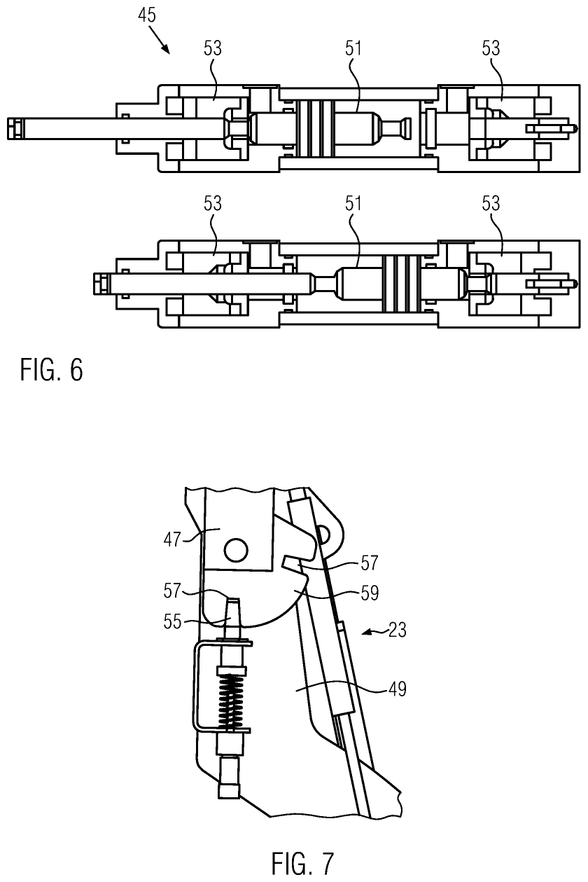

FIG. 6 shows the hydraulic cylinder 45 in a sectional view in a position of a hydraulic piston 51 moved to the left and a position of a hydraulic piston 51 moved to the right. Locking elements 53 establish the end position lock in each case.

FIG. 7 shows a schematic representation of an end position lock of the lifting mechanism 23 by an automatically movable bolt 55, which in the end positions engages with recesses 57 of a disc 59, which rotates with the upper linkage part 47 when the latter is moved by the hydraulic cylinder 45 (not visible in this representation).

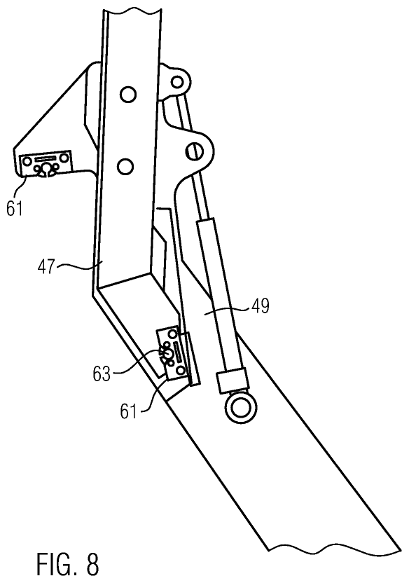

FIG. 8 shows a schematic representation of an end position lock by a rotary snap lock 61. Here, a bolt 63 of the upper, rotatable linkage part 47 engages in the snap lock 61 of the base part 49 in the respective end positions. The snap lock 61 corresponds in its mode of operation approximately to that of a door lock on a passenger car.

Based on the embodiments of a road paver 1 shown above, many variations of the same are possible. For example, the operating unit 21 can be mounted at any convenient location on the road paver 1, for example also on the side. The operating elements 25 may have other expedient functions in addition to those shown, and may have a corresponding form for this purpose, such as, for example, as touch pads or rotary switches. The delayed automatic switch-off of the lighting elements 11 may relate to any lighting element 11 for which this is expedient, for example lighting of the main operator control stand 5 or external lighting of the road paver 1.

What is claimed is:

1. A road paver comprising:
a control system;
a main operator control stand;
a height-adjustable roof;
a main drive;
at least one lighting element;
a paving screed; and
an operating unit which is arranged outside the main operator control stand and has a plurality of operating elements, wherein the operating elements include an operating element that is operable to switch the control system on and/or off, an operating element that is operable to lift and/or lower the roof, an operating element that is operable to start and/or stop the main drive, an operating element that is operable to switch on and/or off the at least one lighting element, and an operating element that is operable to lift and/or lower the paving screed.

2. The road paver according to claim 1, wherein the operating unit is detachably arranged on a portion of the road paver.

3. The road paver according to claim 1, wherein the operating unit is connected to the control system by means of a cable.

4. The road paver according to claim 3, wherein the cable comprises a detachable plug connection.

5. The road paver according to claim 1, wherein the operating unit is connected to the control system by means of a radio connection.

6. The road paver according to claim 1, wherein the operating unit is arranged on the paving screed.

7. The road paver according to claim 1, wherein the operating unit is arranged on a paving screed climb.

8. The road paver according to claim 1 further comprising a lockable cover which, when locked, prevents access to the operating unit.

9. The road paver according to claim 1, wherein the operating unit comprises one or a plurality of display elements, each of which is operable to display information of one component which can be adjusted by means of one of the operating elements.

10. The road paver according to claim 1, wherein the at least one lighting element is configured to go out after a predetermined period of time has elapsed following operation of the operating element to switch on and/or off the at least one lighting element.

11. The road paver according to claim 1 further comprising a lifting mechanism for lifting and lowering the roof, wherein the lifting mechanism comprises an automatically releasable and automatically lockable end position lock.

12. The road paver according to claim 1, wherein the control system is configured to allow starting of the main drive even before the control system itself is fully set to an operating mode after power-up.

13. The road paver according to claim 1, wherein the operating unit comprises operating elements which are provided for controlling functions of the road paver in paving operation.

14. A method for operating a road paver including a control system, a main operator control stand, a height-adjustable roof, a main drive, at least one lighting element, a paving screed and an operating unit which has a plurality of operating elements, the method comprising:
operating an operating element of the plurality of operating elements to switch the at least one lighting element on and/or off;
operating an operating element of the plurality of operating elements to lift and/or lower the roof;
operating an operating element of the plurality of operating elements to start and/or stop the main drive;
operating an operating element of the plurality of operating elements to lift and/or lower the paving screed; and
operating an operating element of the plurality of operating elements to switch the control system on and/or off.

15. The method according to claim 14, wherein the main drive is started before the control system is completely set to an operating mode after being switched on.
